(19) United States
(12) Patent Application Publication
(10) Pub. No.: US 2014/0311466 A1
(43) Pub. Date: Oct. 23, 2014

(54) Coolant Inlet Structures for Heat Exchangers for Exhaust Gas Recirculation Systems

(71) Applicant: CATERPILLAR INC., Peoria, IL (US)

(72) Inventors: Scott R. Schuricht, Edwards, IL (US); Kenneth Dean Themanson, Kewanee, IL (US); Vasanthakumar Ganesan, Dunlap, IL (US)

(73) Assignee: Caterpillar Inc., Peoria, IL (US)

(21) Appl. No.: 13/864,484

(22) Filed: Apr. 17, 2013

(51) Int. Cl. F02M 25/07

(52) U.S. Cl. CPC F02M 25/0737
USPC 123/568.12; 29/428

(57) ABSTRACT

A heat exchanger for an exhaust gas recirculation system is provided, the heat exchanger including a tube core having a plurality of tubes extending from an upstream header of the tube core to a downstream header of the tube core and also having a plurality of coolant channels disposed between and separating the tubes, and a coolant inlet collar disposed about the tube core near the upstream header, the coolant inlet collar being comprised of at least two separately formed pieces that have been joined together.

### TECHNICAL FIELD

The present disclosure relates generally to heat exchangers for the transfer of thermal energy in an exhaust gas recirculation system associated with an internal combustion engine and, more particularly, to devices and/or modifications for use in connection with such heat exchangers that contribute to the efficiency, manufacturability, reliability and/or longevity thereof.

### BACKGROUND

Internal combustion engines burn a hydrocarbon-based fuel or another combustible fuel source to convert the potential or chemical energy therein to mechanical power that may be utilized for other work. The combustion of fuel produces byproducts and emissions that the U.S. Government and other governments regulate. To comply with these regulations, engine manufacturers have developed a number of methods for reducing or treating the emissions created by the internal combustion process. One such apparatus for reducing or treating the emissions is an exhaust gas recirculation (EGR) system. An EGR system is a system in which a portion of the exhaust gasses produced by the combustion process are recirculated and intermixed with the incoming intake air. The use of an EGR system lessens the creation of nitrogen oxides such as NO and NO2, commonly referred to as NOx, during combustion. Because the exhaust gasses are typically still hot after their initial combustion, however, they generally are cooled before being recirculated into the intake air. Accordingly, one of the purposes of EGR systems is to cool the exhaust gas prior to recirculation to avoid disrupting the combustion process and/or to gain additional performance advantages.

The cooling of the exhaust gas in an EGR system before introduction into the engine intake air may be accomplished through the use of heat exchangers. Consistent therewith, U.S. patent application Ser. No. 13/549,936, filed on Jul. 16, 2012, assigned to the assignee of the present application (the entire contents of which are herein incorporated and fully integrated by reference), discloses a heat exchanger of the type that may be used with an EGR system in accordance with the present disclosure as well as a coolant inlet structure for use therewith. Similarly, Japanese Patent Publication 200900131285912 (JP '912), entitled “Cooling Water Inlet Structure of Heat Exchanger for EGR Cooler,” also discloses an EGR heat exchanger and a coolant inlet structure thereof.

While both of these disclosures disclose heat exchangers and coolant inlet structures useable in EGR systems, in some applications, it may be desired to optimize certain aspects of the designs of heat exchangers used in such EGR systems, and in particular, structures located at or proximate coolant inlet sections of such heat exchangers. In particular, it may be desired to have inlet structures for heat exchangers operable for use in EGR systems that contribute to the thermal efficiency of the heat exchanger. Further, it may be desired that these inlet structures be capable of being manufactured in an efficient and cost-effective manner and that the manufactured inlet structures have the desired longevity.

### SUMMARY

In one aspect, the disclosure describes aspects of a heat exchanger for an EGR system associated with an internal combustion engine, and more specifically, to inlet structures for use in connection with such heat exchangers. Specifically, in accordance with one aspect of the disclosure, the disclosed inlet structures may comprise an inlet collar formed from at least two separate pieces that have been combined. More specifically, the inlet collar may be formed from at least two separate pieces that have been brazed, welded, or otherwise combined together

In another aspect of the disclosure, inlet structures in accordance with the disclosure may comprise an inlet channel to an inlet collar of an EGR system that has a geometry that increases the thermal efficiency of the EGR system. In particular, the inlet structure may comprise a coolant feed connection fitted with a flow deflector to direct coolant flow into and around a coolant inlet collar. Additionally, in accordance with other aspects of the disclosure, the inlet structure may comprise a coolant feed connection that is tapered outwardly to more smoothly and efficiently direct coolant flow into a coolant inlet collar.

In another aspect, the inlet structure may comprise structures for manipulating the flow of a coolant into an inlet collar for a heat exchanger used in an EGR system. In particular, in such an embodiment, an inlet flow splitter may be incorporated in a coolant feed elbow to create a more uniform inlet coolant flow thereby increasing the thermal efficiency of the EGR system. In accordance with aspects of the embodiments consistent therewith, the inlet flow splitter may be comprised of a bisecting wall in a coolant feed elbow.

### BRIEF DESCRIPTION OF THE DRAWINGS

FIG. 1 is a schematic diagram representing an internal combustion engine on a machine that includes an EGR system for recirculating exhaust gasses to the combustion process by mixing the gasses with the intake air;

FIG. 2 is a perspective view of a heat exchanger that may be used to cool the exhaust gasses in the EGR system of FIG. 1;

FIG. 3 is a perspective view of the upstream end of the heat exchanger of FIG. 2 with the shell partially retracted to display the header and the plurality of exhaust tubes disposed in the shell;

FIG. 4 is a cross-sectional view taken along line 166 of one embodiment of the heat exchanger of FIG. 2 showing a coolant inlet structure in the form of a collar having a plurality of coolant introduction paths disposed about the tube core to introduce coolant to the coolant channels therein;

FIG. 5 is a cross-sectional view similar to FIG. 4 of another embodiment of the heat exchanger showing a coolant inlet structure in the form of a collar with a coolant introduction slot disposed continuously about the tube core and communicating with the coolant channels therein;

FIG. 6 is a rear perspective view of a multi-piece coolant inlet collar in accordance with an embodiment of the present disclosure;

FIG. 7 is a front perspective, cross-sectional view taken along line 7-7 of the multi-piece coolant inlet collar of FIG. 6;

FIG. 8 is a front perspective, cross-sectional view taken along line 8-8 of the multi-piece coolant inlet collar of FIG. 6;

FIG. 9 is an exploded, front perspective view of a multi-piece coolant inlet collar in accordance with an embodiment of the present disclosure;

FIG. 10 is a front perspective, cross-sectional view taken along line 10-10 of the multi-piece coolant inlet collar of FIG. 9;

FIG. 11 is an exploded, front perspective view of a multi-piece coolant inlet collar in accordance with an embodiment of the present disclosure;

FIG. 12 is a rear perspective, cross-sectional view taken along line 12-12 of the multi-piece coolant inlet collar of FIG. 11;

FIG. 13 is an exploded, front perspective view of a multi-piece coolant inlet collar in accordance with an embodiment of the present disclosure;

FIG. 14 is an exploded, front perspective view of a multi-piece coolant inlet collar in accordance with an embodiment of the present disclosure;

FIG. 15 is a front perspective, cross-sectional view taken along line 15-15 of the multi-piece coolant inlet collar of FIG. 14;

FIG. 16 is a cross-sectional side elevational view of a coolant inlet collar having a flow deflector therein in accordance with an embodiment of the present disclosure;

FIG. 17 is a cross-sectional front plan view of the coolant inlet collar of FIG. 16;

FIG. 18 is a cross-sectional front plan view of a coolant inlet collar having a tapered inlet in accordance with an embodiment of the present disclosure;

FIG. 19 is a perspective view of a coolant feed elbow for a coolant inlet collar having a flow splitter therein in accordance with an embodiment of the present disclosure;

FIG. 20 is a cutaway side elevational view of a coolant feed elbow for a coolant inlet collar having a flow splitter therein in accordance with an embodiment of the present disclosure;

FIG. 21 is a cutaway side elevational view of a coolant feed elbow for a coolant inlet collar having a flow splitter therein in accordance with an embodiment of the present disclosure;

FIG. 22 is a cutaway side elevational view of a coolant feed elbow for a coolant inlet collar having a flow splitter therein in accordance with an embodiment of the present disclosure; and

FIG. 23 is a flow chart illustrating some embodiments consistent with an embodiment of the present disclosure.

### DETAILED DESCRIPTION

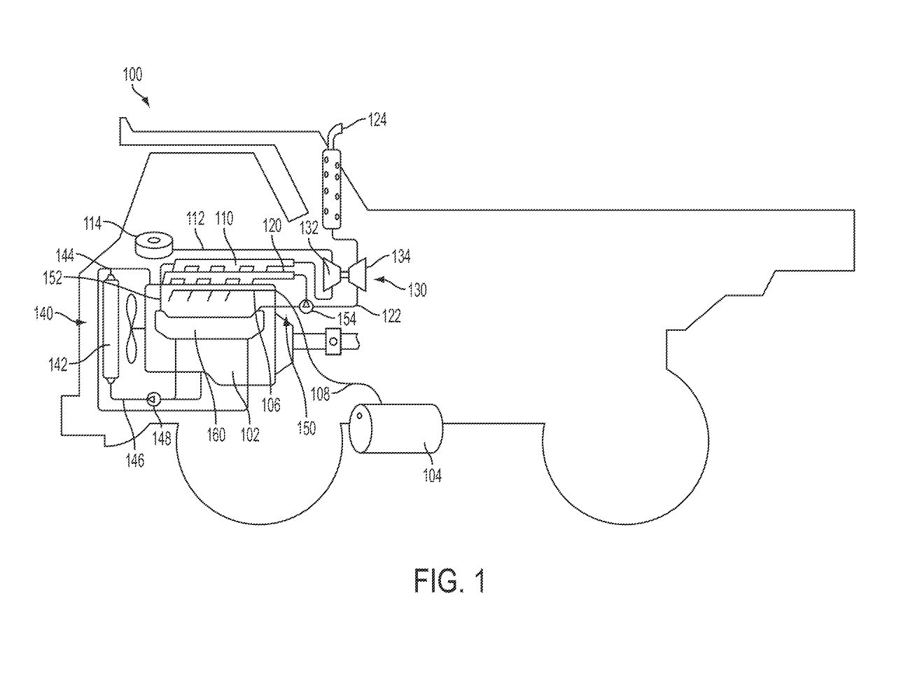

Now referring to the drawings, wherein like reference numbers refer to like elements, there is illustrated a machine 100 powered by an internal combustion engine 102 adapted to combust a fuel to release the chemical energy therein and convert that energy to mechanical power. The machine 100 may be an “over-the-road” vehicle such as a truck used in transportation or may be any other type of machine that performs some type of operation associated with an industry such as mining, construction, farming, transportation, or any other industry known in the art. For example, the machine may be an off-highway truck, earth-moving machine, such as a wheel loader, excavator, dump truck, backhoe, motor grader, material handler or the like. The term “machine” may also refer to stationary equipment like a generator that is driven by an internal combustion engine to generate electricity. The specific machine 100 illustrated in FIG. 1 is a dump truck.

The internal combustion engine 102 may be a compression ignition engine that combusts diesel fuel, though in other embodiments, it may be a spark ignition engine that combusts gasoline or other fuels such as ethanol, bio-fuels, or the like. To store and supply the internal combustion engine 102 with fuel for the combustion process, the machine 100 may include a fuel reservoir 104 that is in fluid communication with a fuel rail 106 on the machine 100 by way of a fuel line 108. To direct intake air used in the combustion process to the internal combustion engine 102, an intake manifold 110 may be disposed over the engine 102 and in fluid communication with the combustion chambers disposed therein. The intake manifold 110 may receive intake air from an intake line 112 that may draw atmospheric air through an air intake filter 114. Similarly, to direct the exhaust gasses produced by the combustion process from the internal combustion engine 102, an exhaust manifold 120 may extend over the engine 102 and may be in fluid communication with the combustion cylinders. The intake manifold 110 and the exhaust manifold 120 are depicted in an overlapping fashion, but in other embodiments may be disposed in any suitable arrangement including being integrally formed into the internal combustion engine 102 itself. The exhaust manifold 120 may direct exhaust gasses to an exhaust line 122 that terminates at an exhaust orifice 124 that releases the gasses back to the atmosphere.

To assist in directing intake air into the internal combustion engine 102, the machine 100 may include a turbocharger 130. The turbocharger 130 may include a compressor 132 disposed in the intake line 112 that compresses intake air drawn from the atmosphere and directs the compressed air to the intake manifold 110. Although a single turbocharger 130 is shown, more than one such device connected in series and/or in parallel with another may be used. To power the compressor 132, a turbine 134 may be disposed in the exhaust line 122 and may receive pressurized exhaust gasses from the exhaust manifold 120. The pressurized exhaust gasses directed through the turbine 134 may rotate a turbine wheel having a series of blades thereon, which powers a shaft that causes a compressor wheel to rotate within a compressor housing pressurizing the intake air.

To remove heat produced by the internal combustion process and cool the internal combustion engine 102, the machine 100 may include a coolant system 140 that may direct a coolant such as water or radiator fluid through the engine 102. The coolant circulating through the engine 102 absorbs heat therein in the form of thermal energy and, upon exiting the engine 102, discharges the thermal energy to the atmosphere. The coolant system 140 may include a radiator 142, such as an air-cooled crossflow radiator disposed in a location where a sufficient amount of air will pass over and/or through it. To deliver cooled coolant to the internal combustion engine 102, the radiator 142 may communicate with a cold line or feed line 144, and to receive heated coolant returning from the engine 102, the radiator 142 may be operatively connected to a hot line or return line 146. To pressurize and forcibly direct the coolant through the coolant system 140, a coolant pump 148 may be disposed in the feed line 144, the return line 146 or elsewhere in the coolant system 140.

To reduce emissions produced by the combustion process, the internal combustion engine 102 may be operatively associated with an exhaust gas recirculation EGR system 150. An EGR system, as will be familiar to those of skill in the art, may redirect a portion of the exhaust gasses discharged from the combustion process back to the intake system and intermix the exhaust gasses with the intake air. The presence of exhaust gasses in the intake air lowers the relative proportion or amount of oxygen available for combustion in the combustion chamber, which results in a lower flame and/or combustion temperature. As a result, the combustion process generates less nitrogen oxides than would be produced in an oxygen rich environment that often results in higher combustion temperatures.

To redirect the exhaust gasses, the EGR system 150 may include an EGR line 152 that communicates with the exhaust line 122 and that may be in fluid communication to the intake manifold 110 or intake line 112. To selectively control the amount of exhaust gasses redirected to the EGR process, the EGR system 150 may include an adjustable EGR valve 154, such as a butterfly valve, disposed in the EGR line 152. Please note, that the illustration shows a “hot side” application wherein the EGR valve 154 is located between the cooler inlet and exhaust manifold. It is to be understood, however, that the present disclosure is equally applicable to a “cold side” valve arrangement where the EGR valve 154 is located between the cooler outlet and intake manifold, as well as many other configurations/set ups, consistent with the disclosure herein. In the illustrated embodiment, the EGR line 152 accesses the exhaust line 122 upstream of the turbine 134 so as to receive high-pressure exhaust gasses that have not lost pressure through the turbine 134 and is thus referred to as a high-pressure EGR system. In other embodiments, the EGR line 152 may intersect the exhaust line 122 downstream of the turbine 134 to receive depressurized exhaust gasses and may thus be considered a low-pressure EGR system.

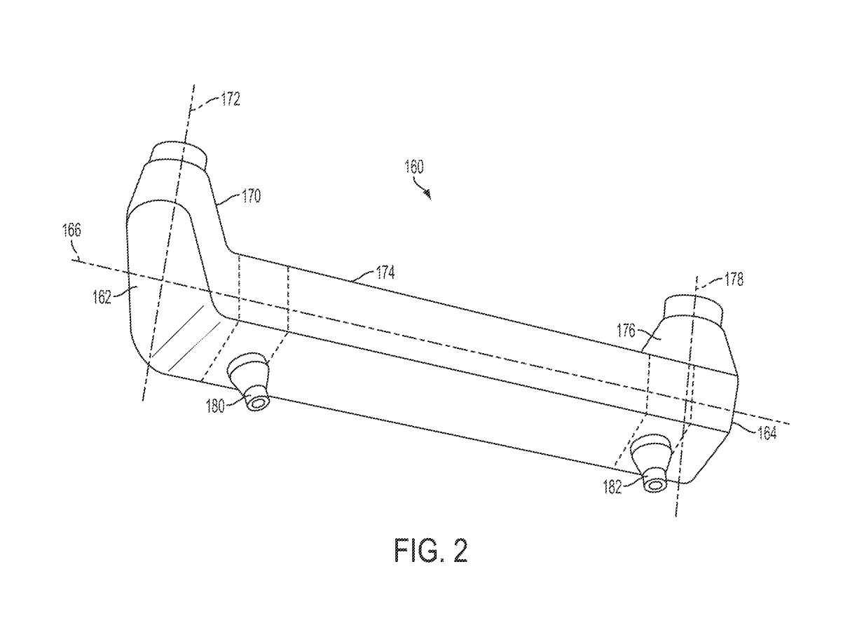

To cool the redirected exhaust gasses prior to recirculation with the intake air, the EGR system 150 may include a heat exchanger 160 operatively associated with the internal combustion engine 102 and the coolant system 140. In the illustrated embodiment, the heat exchanger 160 may be attached to the side of the internal combustion engine 102 but, in other embodiments, it may be located elsewhere on the machine 100. Referring to FIGS. 1 and 2, the heat exchanger 160 may be an elongated device extending between an upstream end 162 and a downstream end 164 so that it thereby defines or delineates a longitudinal axis line 166. The heat exchanger 160 may have a generally overall rectangular cross-sectional shape but in other embodiments may have any other suitable cross-sectional shape, like circular, octagonal, etc.

To receive the exhaust gasses, the heat exchanger 160 may have an exhaust gas inlet diffuser 170 disposed at the upstream end 162 and that may connect to the EGR line 152 downstream of the EGR valve 154 and upstream of the intake manifold 110. The inlet diffuser 170 may widen from its connection point to the EGR line 152 to its attachment to the elongated, rectangular main body 174 of the heat exchanger 160 to assist in slowing the incoming, high-pressure exhaust gasses. Additionally, in the illustrated embodiment, the inlet diffuser 170 may define an inlet axis line 172 aligned with the flow direction of the incoming exhaust gasses and that is generally perpendicular to the longitudinal axis line 166 of the heat exchanger 160. The inlet diffuser 170 may therefore direct the incoming exhaust gasses through a 90° turn or bend to realign flow with the longitudinal axis line 166 and uniformly aid in distributing the exhaust gasses to the internal components of the heat exchanger 160. In an embodiment, the inlet diffuser 170 may include a pivotal blade or baffle that may move within the diffuser 170 to increase or restrict the flow area therein and thus help control the flow of exhaust gasses. To return the exhaust gasses to the EGR system 150 after passing through the heat exchanger 160, the heat exchanger 160 may include a substantially identical exhaust gas exit diffuser 176 disposed at the downstream end 164 that may connect with the remainder of the EGR line 152 to communicate with the intake manifold 110. The exit diffuser 176 may define an exit axis line 178 that is substantially parallel to the inlet axis line 172 and perpendicular to the longitudinal axis line 166. However, alternative embodiments may include configurations wherein the inlet diffuser 170 and exit diffuser 176 have non-coplanar axis lines.

To receive cooled coolant from the coolant system 140, the heat exchanger 160 may include a coolant feed connection 180 disposed proximate to the upstream end 162 in fluid communication with the coolant feed line 144. The coolant feed connection 180 may be any suitable type of connection such as a hose bib, a threaded hose fitting, or a more complex connection such as a quick-release fitting, or a permanent connection such as done by welding or brazing.

The coolant feed inlet 180 may extend from the main body 174 of the heat exchanger 160 perpendicular to the longitudinal axis line 166 and parallel to the inlet axis line 172. To simplify connection with the coolant feed line 144, in one embodiment, a single coolant feed inlet 180 may be included on the heat exchanger 160.

To discharge the heated coolant from the heat exchanger 160, a coolant return connection 182 may be attached to the main body 174 proximate to the downstream end 164 and may be oriented perpendicular to the longitudinal axis line 166 and parallel to the exit axis line 178. In an alternative embodiment, the coolant feed inlet 180 may extend from the main body 174 of the heat exchanger 160 perpendicular to the longitudinal axis line 166 and substantially orthogonal to the inlet axis line 172. Similarly, in an alternative embodiment, the coolant return connection 182 may be oriented perpendicular to the longitudinal axis line 166 and substantially orthogonal to the exit axis line 178.

Because the exhaust gas inlet diffuser 170 and coolant feed connection 180 are located proximate to the upstream end 162, and the exhaust gas exit diffuser 176 and coolant return connection 182 are located proximate to the downstream end 164, flow of both mediums, exhaust gas and coolant, will be generally directed from the upstream end 162 to the downstream end 164. This arrangement is commonly referred to as a parallel flow-heat exchanger 160. In other embodiments of the disclosure, though, the inlets, exits and connections may be arranged for a counter-flow heat exchanger 160 wherein exhaust gasses and coolant enter and exit at opposite ends of the heat exchanger 160. Additionally, the described embodiment of the heat exchanger 160 is a single pass design in which the two conducting mediums make a single pass through the exchanger, but the disclosure is also applicable to multipass arrangements in which the mediums are directed to make multiple passes through the heat exchanger 160. The particular flow arrangement may depend in part upon size constraints, volume capacity and desired thermal efficiencies, and any suitable flow arrangement or variation thereof are contemplated as within the scope of the claims.

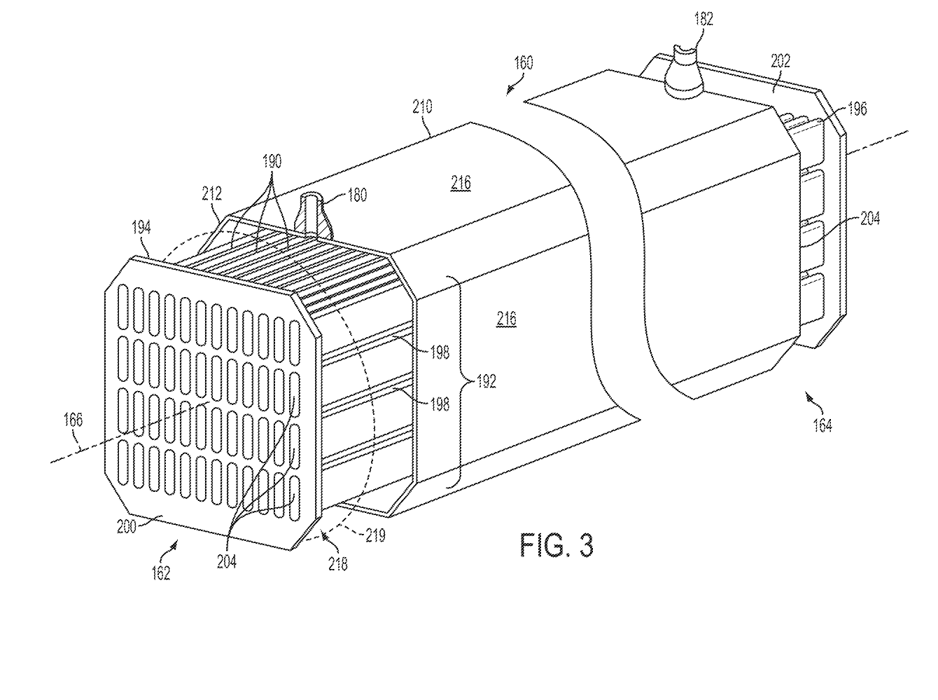

Referring to FIG. 3, there is illustrated the upstream end 162 and the downstream end 164 of a heat exchanger 160 with the diffusers removed to better illustrate the internal components of the heat exchanger 160. The heat exchanger 160 may be of the common shell-and-tube design in which a plurality of hollow tubes 190 conducting one medium is enclosed in a shell containing the other medium that flows around and past the tubes 190. In FIG. 3, the hollow tubes 190 may be arranged in parallel as a plurality of tubes 190 collectively referred to as a tube bundle or tube core 192. The plurality of tubes 190 and tube core 192 may be further aligned parallel to the longitudinal axis 166 of the heat exchanger 160. The tubes 190 may be generally elongated, straight structures extending coextensive with each other so that the tube core 192 includes an upstream face 194 and an opposing downstream face 196 that may correspond to the length of the main body 174 of the heat exchanger 160. The plurality of tubes 190 may be arranged in a square or rectangular pattern but in other embodiments may have other arrangements. The tubes 190 may be made from any suitable material such as a thin-walled metal like aluminum, steel, or copper.

In the present embodiment, the hollow tubes 190 may be designated to conduct the exhaust gasses and maintain separation of the exhaust gasses from the coolant flowing over and around the tubes 190. To define coolant channels 198 in the tube core 192 for flow of coolant between the tubes 190, the plurality of tubes 190 may be spaced apart from each other along their lengths so that elongated voids are created between and separate the tubes 190. To maintain the plurality of tubes 190 in a fixed, spaced-apart arrangement and thereby maintain the coolant channels 198, the elongated tubes 190 may be fixed at one end to an upstream header 200 and at the opposite end to a downstream header 202. Thus, the upstream header 200 demarcates the upstream face 194 of the tube core 192 and the downstream header 202 demarcates the downstream face 196. The headers 200, 202 may be relatively thick, flat plates of a metallic material like steel or aluminum arranged perpendicular to the longitudinal axis line 166. To provide access to the interior of the hollow tubes 190, a plurality of apertures 204 may be disposed through the headers 200, 202 with each aperture aligned to one corresponding tube. The tubes 190 may be welded, brazed or otherwise joined to the headers 200, 202 to align with their respective apertures 204. In the illustrated embodiment, the apertures 204 are oblong slots but, in other embodiments, could have other shapes.

The tube core 192 may be disposed in a hollow, outer housing or core shell 210. The core shell 210 may extend between a first rim 212 and an opposite second rim 214 and is generally disposed over and around the tube core 192 to retain the coolant within the coolant channels 198. The illustrated core shell 210 is a generally four-sided structure with four, integral longitudinal sides 216 to correspond to the rectangular or square arrangement of the tubes 190 in the tube core 192 but in other embodiments could have different shapes. Like the headers 200, 202, the core shell 210 may be made from a metal such as steel or aluminum. The coolant feed connection 180 and the coolant return connection 182 may be disposed through one side 216 of the core shell 210 slightly behind the headers 200, 202 to introduce and receive coolant to and from the tube core 192. Accordingly, the headers 200, 202 constrain coolant in the core shell 210 to prevent coolant from entering the inlet and exit diffusers 170,176 and intermixing with the exhaust gasses.

Referring to FIGS. 2 and 3, it may be appreciated that the incoming coolant will initially flow into the tube core 192 in a singular direction perpendicular to the longitudinal axis line 166 due to the orientation of the single coolant feed connection 180. The incoming coolant realigns approximately 90° to be parallel with the longitudinal axis line 166 and flows lengthwise along the tube core 192 to exit perpendicularly from the other end. This fluid realignment causes inconsistent distribution of coolant proximate the upstream and downstream faces 194, 196 of the tube core 192 such that relatively cooler, incoming coolant might not adequately replenish existing coolant completely across the upstream and downstream faces 194. For example, pools of coolant may become trapped and stagnate at the corners of the tube core 192 opposite the coolant feed inlet 182 as indicated by arrow 218. Areas 218 of localized thermal buildup may result, possibly leading to boiling or degradation of the trapped coolant. Additionally, because the tube core 192 joins the upstream and downstream headers 200, 202 in these areas 218, the thermal buildup may cause thermal expansion of the parts resulting in cracking or leak formation proximate the joints. Coolant and exhaust gasses could intermix allowing coolant to access the combustion chamber of the internal combustion engine 102 possibly leading to a hydro-lock condition.

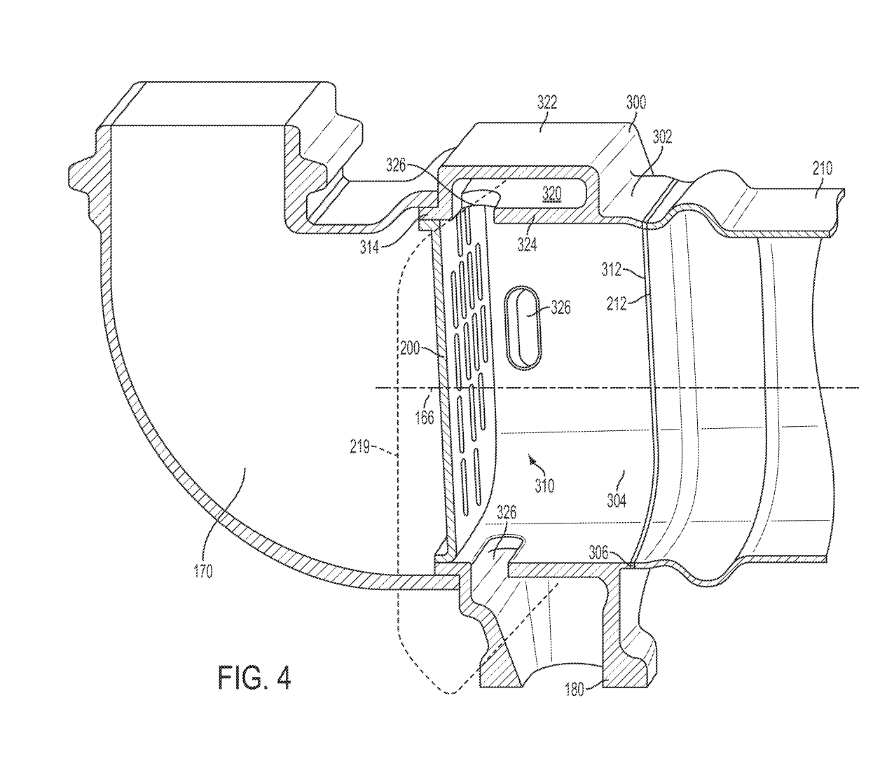

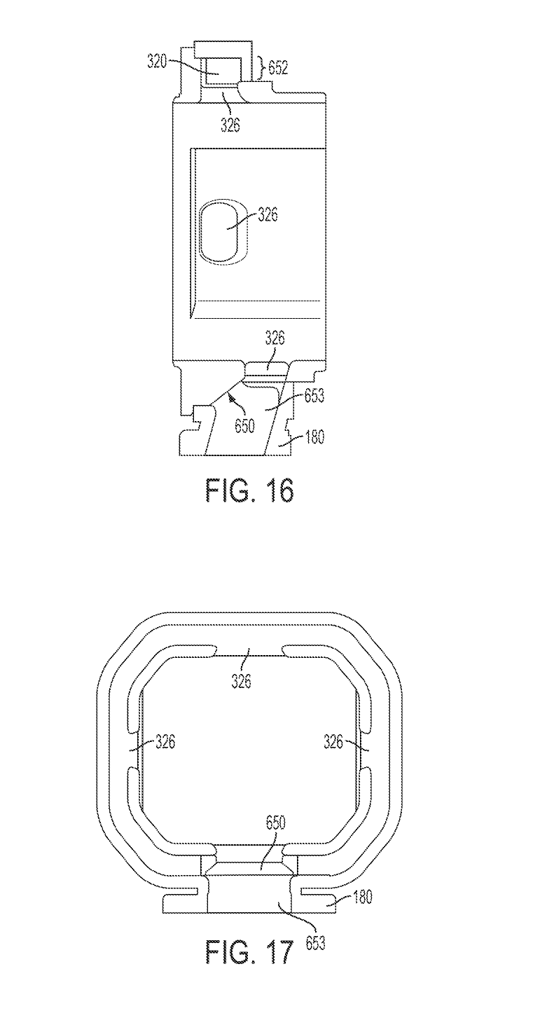

In accordance therewith, the heat exchanger 160 may therefore be equipped with coolant inlet structures which may allow for improved distribution of coolant in the EGR system generally, and, specifically, to various components thereof, thereby addressing potential issues of inadequate distribution and localized heating. Non-limiting examples of such coolant inlet structures, all of which will be discussed in detail below, include coolant inlet lines (or the like) which provide multiple coolant introduction paths or ports for coolant into and around the tube core 192 (see, e.g. FIGS. 4-15) and coolant feed connections (see, e.g. FIGS. 16-22) which may improve coolant flow into the body of a coolant inlet line or the heat exchanger 160 itself.

Referring first to FIGS. 4-6, the heat exchanger 160 may include a coolant inlet collar 300, having a coolant duct 320 associated therewith, or a coolant inlet ring disposed substantially about the tube core 192 at the upstream end 162. For example, the coolant inlet collar 300 may circumscribe the tube core 192 in an imaginary loop 219 generally indicated by the dashed circle 219 in FIG. 3. The coolant inlet collar 300 may provide multiple coolant introduction points or paths into the tube core 192. The introduction paths may be inwardly directed toward the centrally disposed longitudinal axis line 166 so that at least a portion of the incoming coolant will converge at the longitudinal axis line 166 before realigning to flow lengthwise through the heat exchanger 160. The central convergence of incoming coolant from multiple sides 522 of the tube core 192 or from multiple introduction paths may provide for a more uniform distribution of coolant flow across the upstream face 194 of the tube core 192 and the adjacent upstream header 200. In other embodiments, the coolant inlet line may extend approximately halfway around the tube core 192 and may communicate with fluid introduction paths diametrically opposed to each other across the tube core 192 so as to inwardly direct coolant toward each other and to converge at the longitudinal axis line 166.

Referring to FIG. 4, there is illustrated an embodiment of the heat exchanger 160 with a coolant inlet collar 300 formed as a continuous, ring-like structure that, because of the square arrangement of the tubes 190, may have a corresponding square outline. Forming the square outline may be a first sidewall 302, an integral second sidewall 304 depending at a 90° angle from the first sidewall 302, a third sidewall 306 opposite the first sidewall 302, and a fourth sidewall that is not shown for clarity purposes but would be opposite the second sidewall 304. The square outline of the inlet collar 300 defines an interior void or interior region 310. Accordingly, when attached as part of the heat exchanger 160, the inlet collar 300 may be disposed about and surround the longitudinal axis line 166 that passes centrally through the interior region 310. It should be noted that while the inlet collar 300 disclosed herein is illustrated having a generally square shape, the inlet collar may be of any desired and/or operable shape, including, but not limited to round, oval, rectangular, etc., as may be considered useful depending on a particular application.

The inlet collar 300 may have a width provided by the integral first sidewall 302, second sidewall 304, third sidewall 306, and fourth sidewall to faun a first surface or first edge 312 and an opposing second surface or second edge 314, both of which follow the substantially square outline of the inlet collar 300. The first edge 312 may be joined to the correspondingly shaped first rim 212 of the core shell 210 by welding, brazing or the like. Constrained at the opposite second edge 314 of the inlet collar 300 and traversing the interior region 310 is the upstream header 200. For example, the header 200 and the second edge 314 may be joined along abutting flange structures by brazing, welding or the like. When the tube core 192 is included and interfaced at its upstream face 194 with the upstream header 200, the inlet collar 300 may be disposed about and surround the tube core 192 coextensively with the upstream face 194.

To distribute coolant substantially about the tube core 192, the inlet collar 300 may include a hollow, enclosed coolant duct 320 that is generally aligned along the loop 219 to circumscribe the interior region 310. The coolant duct 320 may be a generally flat, hollow void external of the first sidewall 302, second sidewall 304, third sidewall 306 and fourth sidewall that is enclosed by a duct cover 322 disposed about the exterior of the inlet collar 300. The coolant duct 320 may be separated from the interior region 310 by an inner barrier wall 324 that, in the illustrated embodiment, may be formed by portions of the first sidewall 302, second sidewall 304, third sidewall 306 and fourth sidewall.

Specific introduction points or paths may be disposed through the barrier wall 324 so that coolant flowing in the coolant duct 320 may flow or pass to the tube core 192. In the embodiment shown in FIG. 4, the introduction points may be formed as a plurality of oblong orifices 326 disposed through the barrier wall 324 establishing fluid communication between the duct 320 and the interior region 310. In the illustrated embodiment, at least one orifice 326 is associated with each of the first sidewall 302, second sidewall 304, third sidewall 306 and fourth sidewall of the inlet collar 300 but other embodiments may have different shapes, numbers, or arrangement of the orifices 326. Moreover, while the coolant duct 320 may circumscribe and direct fluid around the longitudinal axis line 166 in the direction of the loop 219, the orifices 326 are oriented to direct fluid inwardly toward the longitudinal axis line 166 so that at least a portion of the coolant may converge at the longitudinal axis line 166. In other words, the orifices 326 are arranged to direct coolant radially inward toward the common longitudinal axis line 166 from the surrounding coolant duct 320. For example, referring to FIG. 4, the opposing orientations of the orifices 326 associated with the first sidewall 302 and the opposite third sidewall 306 of the inlet collar 300 introduces fluid inwardly toward the longitudinal axis line 166 from two different directions. Multiple introduction paths, directions or approaches for introducing coolant to the tube core 192 facilitates distributing fresh coolant uniformly across the header 200 and the adjacent upstream face 194 of the tube core 192.

In another embodiment, rather than completely circumscribe the tube core 192, the coolant inlet line may partially circumscribe the tube core 192, for example, approximately halfway. Referring to FIG. 4, the inlet collar 300 may be constructed so that the coolant duct 320 extends around three of four of the sidewalls 302, 304, 306. In such an arrangement, the coolant would still be directed about three sides 522 of the coolant inlet collar 300 and would still be directed radially inward by the orifices 326 through three sides 522 of the tube core 192 to converge at the longitudinal axis line 166. In the illustrated embodiment, at least two orifices 326 are opposed 180° across from each other such that two coolant inlet paths are directed at each other in a converging manner. In this embodiment, the coolant inlet line would still be substantially disposed about the tube core 192.

To communicate with the coolant system 140, the coolant feed connection 180 may be disposed on the inlet collar 300, for example, protruding from the bottom second side 306 of the inlet collar 300. The coolant duct 320 may be in fluid communication with the coolant feed connection 180. An advantage of this arrangement is that a single connection point such as a hose fitting may be made to the coolant system 140 and still distribute coolant substantially around and about the tube core 192 to provide multiple introduction paths in multiple directions radially inward toward the common longitudinal axis line 1.66. To recover heated coolant from the heat exchanger 160, in one exemplary embodiment a similar coolant outlet 182 collar may be disposed at the downstream end 164 so that coolant is uniformly removed from the downstream face 196 of the tube core 192. Alternative exemplary embodiments include configurations wherein the outlet 182 does not include a collar configuration. The inlet collar 300 may be made from metal or another suitable material and may be made as a cast part, for example, by lost wax or investment casting.

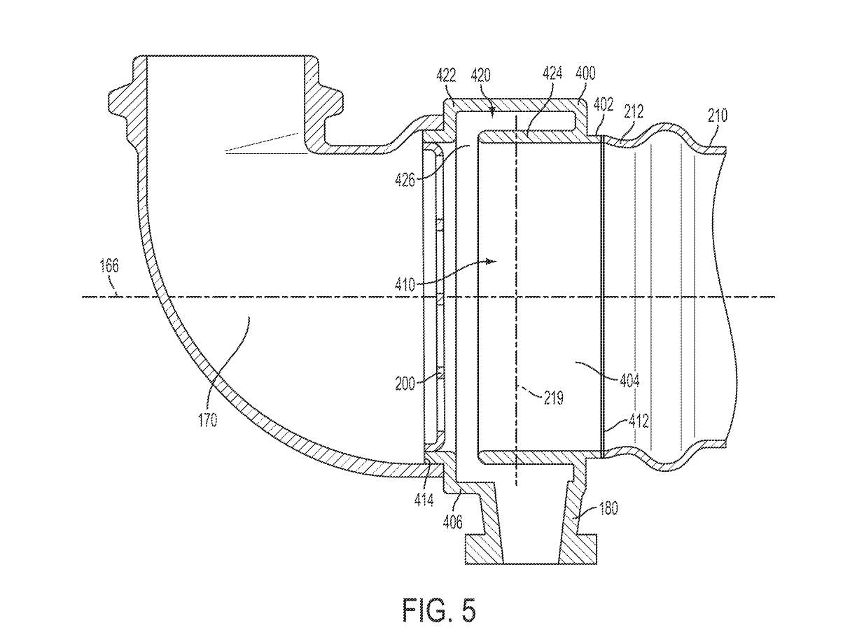

Referring to FIG. 5, there is illustrated another embodiment of an inlet collar 400 for uniformly distributing coolant into the tube core 192 of a heat exchanger 160. The inlet collar 400 may again have a generally square outline including a first sidewall 402, a second sidewall 404, a third sidewall 406, and a fourth sidewall that for clarity is not explicitly depicted. The square outline of the sidewalls 605 surrounds and delineates an interior void or interior region 410. The inlet collar 400 may be joined or attached along a first edge 412 that corresponds to the square outline foamed by the integral sidewalls 605 to the correspondingly shaped first rim 212 of the core shell 210. The second edge 414 of the inlet collar 400 may constrain the upstream header 200 that traverses the interior region 410. The second edge 414 also joins to the exhaust gas inlet diffuser 170 that directs the incoming exhaust gasses through the header 200 and into the interior region 410.

To direct the coolant about the inlet collar 400 for uniform distribution into the tube core 192, the inlet collar 400 may include a coolant duct 420 disposed continuously about the exteriors of the first sidewall 402, second sidewall 404, third sidewall 406 and fourth sidewall so that the duct 420 circumscribes the centrally disposed longitudinal axis line 166. The coolant duct 420 may be a low, flat, void that is enclosed by an external duct cover 422 joined to and partially offset from the sidewalls 605. To separate the coolant duct 420 from the interior region 410, a barrier wall 424 may be formed from the portions of the first sidewall 402, second sidewall 404, third sidewall 406 and fourth sidewall underneath the duct cover 422 so that the barrier wall 424 serves as the interior of the duct 420. In the illustrated embodiment, the coolant duct 420 may trace the outline disposed around and circumscribing the longitudinal axis line 166 by the loop 219 in a substantially annular manner.

To introduce coolant from the coolant duct 420 into the interior region 410 and the upstream face 194 of the tube core 192 that will be disposed therein, an introduction path may be established by a slot 426 disposed through the barrier wall 424 continuously along the first sidewall 402, second sidewall 404, third sidewall 406 and fourth sidewall. The slot 426 therefore forms an inwardly directed flow path that is generally radially oriented toward the longitudinal axis line 166 so that at least a portion of the incoming coolant may converge at the central longitudinal axis line 166. Moreover, the slot 426 may be shifted closer to the second edge 414 than the first edge 412 so that radially incoming coolant may flow adjacent or proximate to the upstream header 200. The continuous or uninterrupted design of the slot 426 facilitates uniform distribution of coolant across the upstream header 200 and upstream face 194 of the tube core 192 that will be adjacent to the header 200. The width of the slot 426 may be dimensioned proportional to the width of the coolant duct 420 so that coolant is evenly distributed about the duct 420 for uniform introduction to the interior region 410 from substantially all directions. Alternative embodiments include configurations wherein the width of the slot 426 may be varied depending on a distance from the coolant feed connection 180; for example, the width of the slot 426 may be greatest at a location disposed furthest from the coolant feed connection 180.

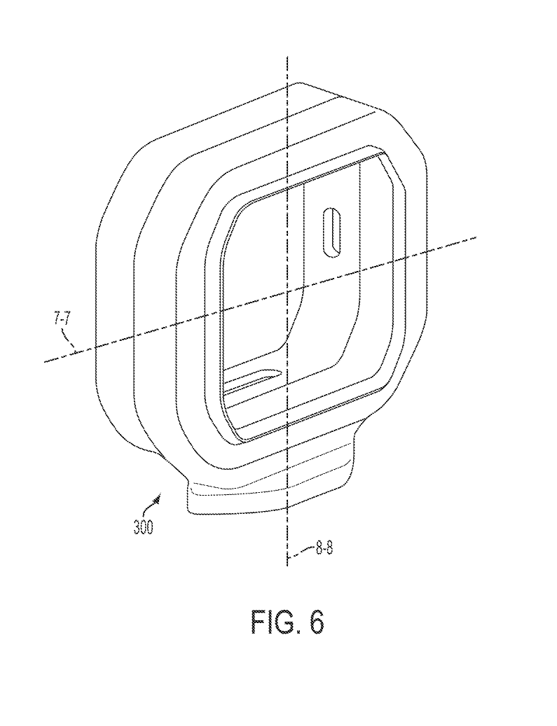

Given the difficulty of forming the coolant inlet collar 300 from a single casting, as well as issues of reliability related thereto, it has been found that the coolant inlet collars 300, 400 may be formed from multiple pieces that are then brazed, welded or otherwise joined together in accordance with an aspect to of the disclosure as shown in FIGS. 6-15.

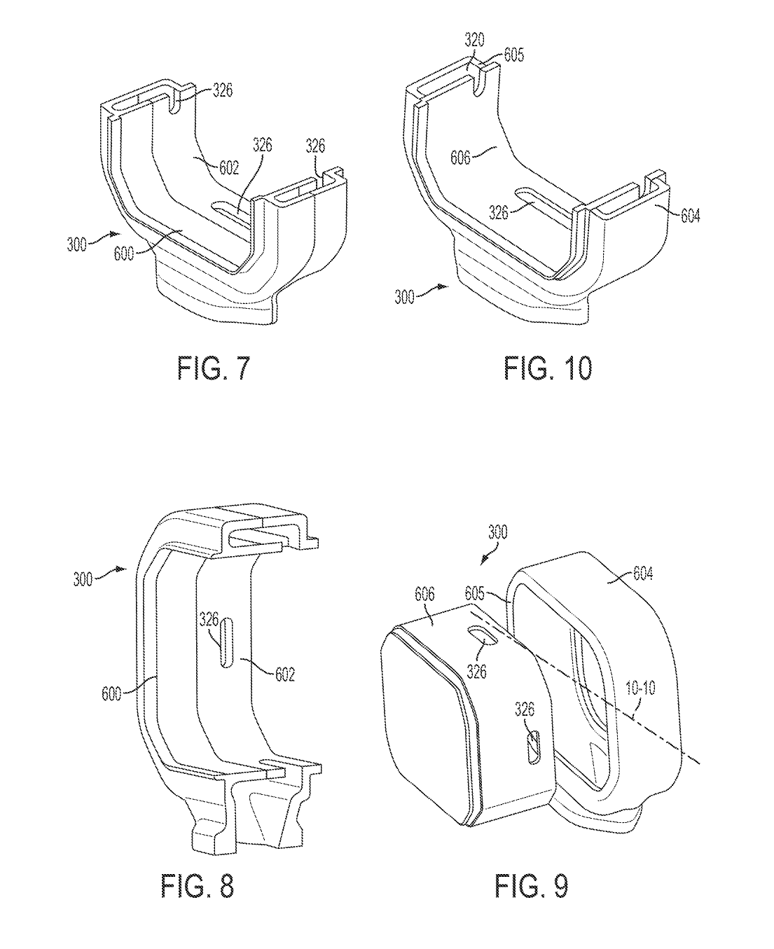

Referring to FIGS. 7 and 8, for example, the coolant inlet collar 300 may be formed as a first half 600 and a second half 602 that may be brazed, welded, or otherwise combined to form a completed coolant inlet collar 300. In accordance with this disclosed embodiment, the first half 600 and second half 602 may be formed by bisecting the coolant inlet collar 300 radially along either lines 7-7 (FIG. 7) or 8-8 (FIG. 8). It is noted that, based upon the geometry of the coolant inlet collar 300, first half 600 and second half 602 are not mirror images of each other and that while orifices 326 are shown as being formed in the first half 602, they could be formed in the second half 600 or in-between the two, in accordance with an aspect of the disclosure.

Referring to FIGS. 9 and 10, the coolant inlet collar 300 may be comprised of an outer sleeve portion 604 and an inner core portion 606 that may be brazed, welded or otherwise joined joined in accordance with an aspect to of the disclosure. In accordance with this embodiment, the outer sleeve portion 604 may include sidewalls 605 incorporated thereon in order to form duct 320.

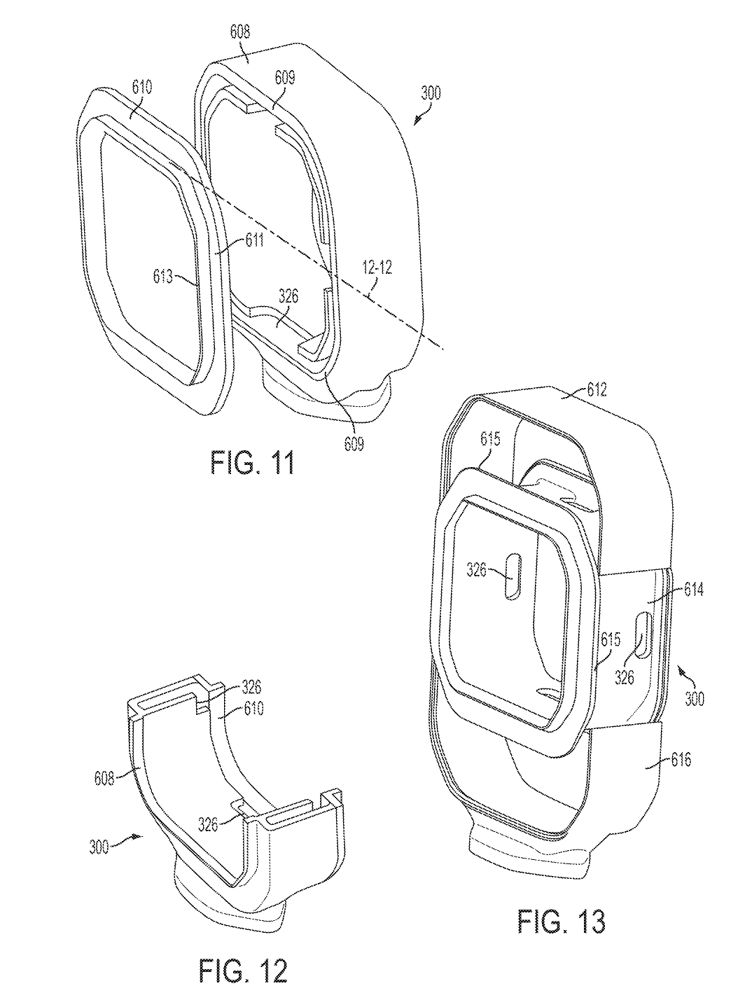

Referring to FIGS. 11 and 12, the coolant inlet collar 300 may be comprised of a core portion 608, having an edge face 609, and a faceplate 610 that may be brazed, welded or otherwise joined together in accordance with an aspect to of the disclosure. In accordance with this embodiment, the faceplate 610 may have a flange portion 611 and a collar portion 613 such that when the faceplate 610 is joined to the core portion 608 at the edge face 609, coolant fluid is prevented from flowing outside of the coolant inlet collar 300.

Referring to FIG. 13, the coolant inlet collar 300 may be comprised of an upper portion 612, middle portion 614, and lower portion 616 that may be brazed, welded, or otherwise joined together in accordance with an aspect of the disclosure. In accordance with this embodiment, the middle portion 614 may have encircling flanges 615 such that when the upper 612 and lower 616 portions are joined thereto, duct 320 is formed therein.

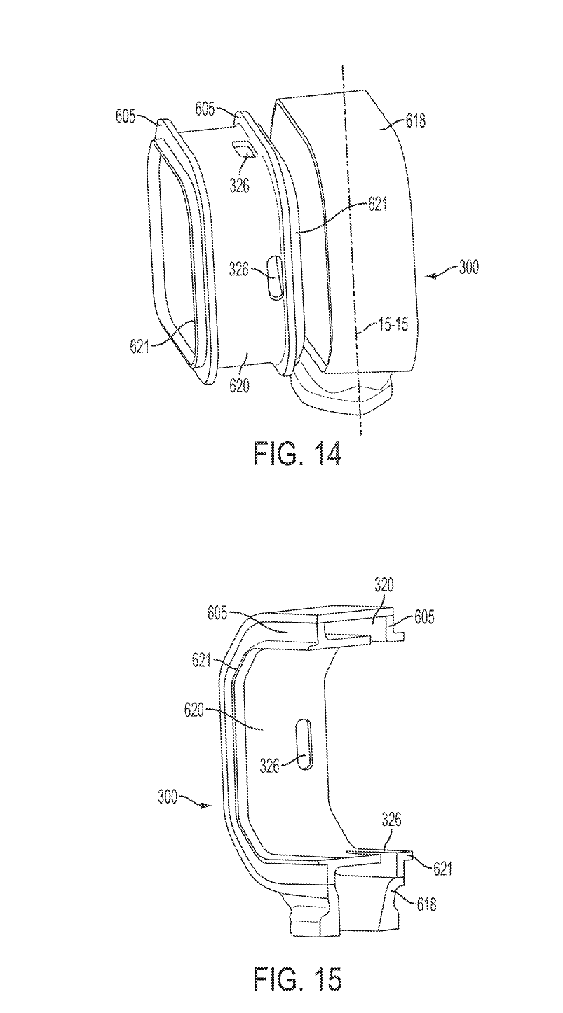

Referring to FIGS. 14 and 15, the coolant inlet collar 300 may be comprised of an outer portion 618 and an inner portion 620 that may be brazed, welded or otherwise joined together in accordance with an aspect to of the disclosure. In accordance with this embodiment, the inner portion 620 may include sidewalls 605 incorporated thereon to form duct 320 and have flanges 621 on either side thereof.

As discussed above, coolant feed connections are provided which may improve coolant flow into the body of a coolant inlet line (such as coolant inlet collar 300, 400) or the heat exchanger 160 itself. Referring first to FIGS. 16 and 17, to distribute coolant to the coolant inlet collar 300 evenly and efficiently, the interior channel 653 of the coolant feed connection 180 may be fitted with a tapered flow deflector 650 to deflect coolant flow around to the sides 522 of the coolant inlet collar 300. Additionally, the depth 652 of the coolant duct 320 may be varied, depending on the application, to allow for efficient coolant flow around the coolant duct 320 and into the interior region 310. Specifically, it has been found that depths from approximately 6 mm to 12 mm are effective and operable within the scope of the disclosure. However, when a depth 652 of coolant duct 320 is less than 6 mm, the flow of coolant into the heat exchanger 160 may be restricted by increased backpressure such that insufficient coolant flow is achieved. Similarly, if the depth 652 of the coolant duct 320 is increased beyond 12 mm, the pressure in the inlet collar 300 may be insufficient to promote adequate flow into the heat exchanger 160 via all orifices 326, and may cause most of the flow to enter only though the opening directly above the coolant inlet port 180.

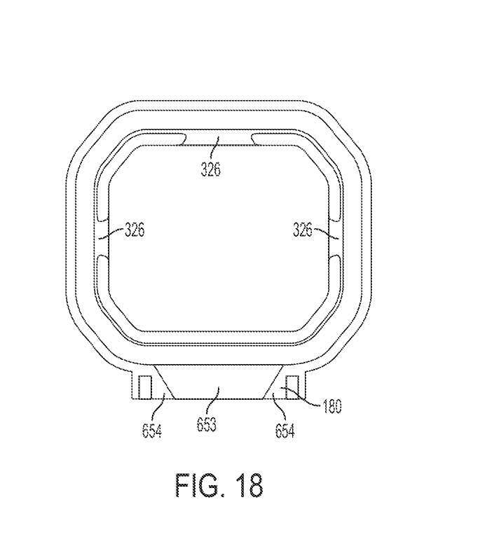

Referring to FIG. 18, to distribute coolant to the coolant inlet collar 300 evenly and efficiently, the interior channel 653 of the coolant feed connection 180 may be tapered outwardly 654 to direct coolant flow into the coolant inlet collar 300.

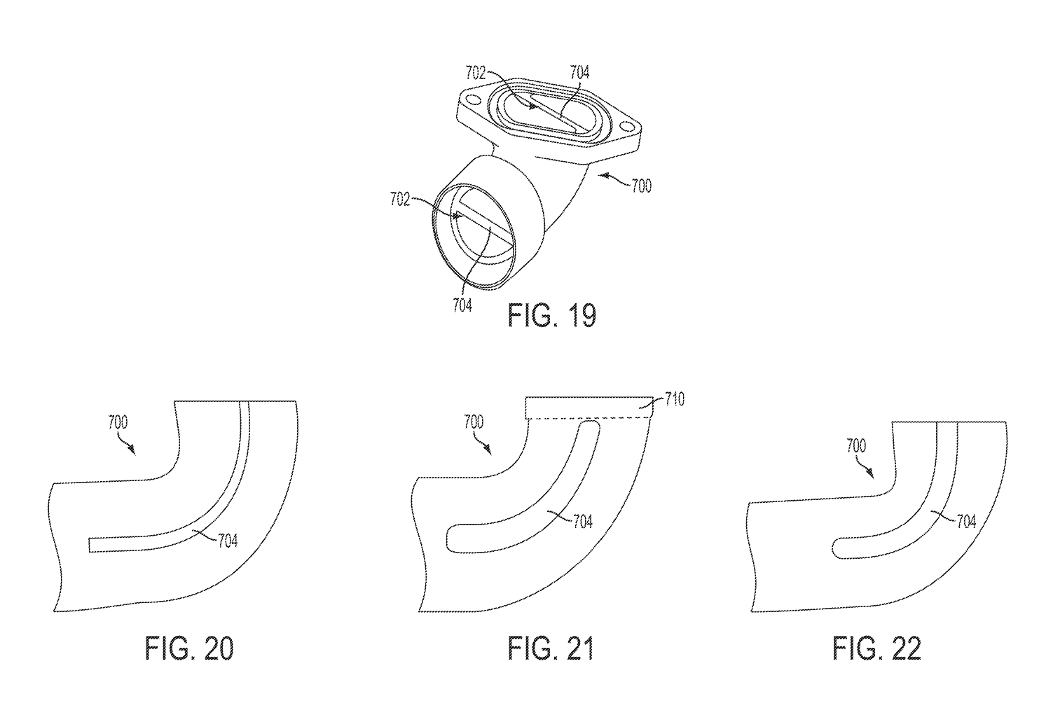

Referring to FIG. 19, the coolant feed connection 180 may be comprised of a coolant feed elbow 700 having a flow splitter 702 fitted therein. The flow splitter 702 may be comprised of a transversely-oriented wall 704 extending either completely or partially through the coolant feed elbow 700 thereby bisecting the feed elbow 700. In selecting the thickness of the transversely-oriented wall 704, it has been found that transversely-oriented wall 704 may be of any operable width depending on the application. Specifically, it has been found that transversely-oriented wall 704 widths between approximately 1 mm and 10 mm, and more specifically, approximately 3 mm and 6 mm are operable within the scope of the disclosure.

Referring to FIG. 20, the transversely-oriented wall 704 may be approximately 3 mm in width. In accordance with this disclosed embodiment, the transversely-oriented wall 704 may terminate at the entrance to the coolant inlet collar 300.

Referring to FIG. 21, the transversely-oriented wall 704 may be approximately 6 mm in width. In accordance with this disclosed embodiment, the transversely-oriented wall 704 may terminate prior to the entrance to the coolant inlet collar 300 forming a collar 710.

Referring to FIG. 22, the transversely-oriented wall 704 may be approximately 6 mm in width. In accordance with this disclosed embodiment, the transversely-oriented wall 704 may terminate at the entrance to the coolant inlet collar 300.

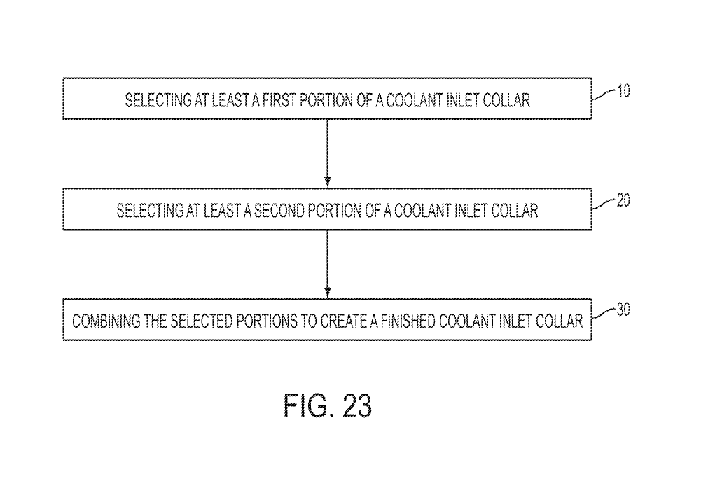

Referring to FIG. 23, at least one embodiment of the present disclosure is illustrated. Specifically, a method of assembling an inlet collar for an exhaust gas recirculation system in accordance with present disclosure is disclosed comprising the steps of: selecting at least a first portion of a coolant inlet collar 10; selecting at least a second portion of a coolant inlet collar 20; and combining the selected portions to create a finished coolant inlet collar 30. The method may optionally include: combining the portions by brazing or welding; selecting an outer sleeve portion and an inner core portion that is shaped to be received within the outer sleeve portion; selecting a first portion having sidewalls incorporated thereon; selecting a second portion having sidewalls incorporated thereon; selecting a first portion including a core portion having an edge face thereon and a second portion comprising a faceplate, wherein the faceplate is shaped to be received on the edge face of the core portion; a first portion comprising a first half and a second portion comprising a second half; etc.

### INDUSTRIAL APPLICABILITY

The present disclosure is applicable to coolant inlet structures for heat exchangers in general and, in particular to heat exchangers that may be used to cool exhaust gasses prior to incorporation with intake air in EGR systems. While coolant inlet structures for heat exchangers of this type have been used in the past, sometimes it may be desired to optimize certain aspects of the designs of these structures. In particular, it may be desired to have inlet structures for heat exchangers operable for use in EGR systems that contribute to the thermal efficiency of the heat exchanger 160. Further, it may be desired that these inlet structures be capable of being manufactured in an efficient and cost-effective manner and that the manufactured inlet structures have the desired longevity.

More specifically, it has been found that coolant inlet structures for heat exchangers, particularly those having complicated structural features (such as inlet orifices 326, channels, sidewalls 605, etc.) may be difficult to manufacture in single castings. Accordingly, it may be desirable in some applications, to produce a coolant inlet structure, such as a coolant inlet collar 300 in multiple pieces that are then, thereafter, joined together. Methods for joining could include, but are not limited to, welding, brazing, and the like.

It has also been found that some prior art tubes 190 have been known to fail due to heat stress. It has been found that such failures typically occur at a point or location most distant from the coolant ingress point into the coolant inlet structure along a coolant inlet face. Accordingly, it may be desirable, in some applications, to provide inlet structures that have geometries that increase the thermal efficiency of the EGR system 150 and the longevity of the cooler core itself. In particular, the inlet structure may comprise a coolant feed connection 180 fitted with a flow deflector to direct coolant flow into and around a coolant inlet collar 300. Additionally, in some applications, it may be desired to provide an inlet structure comprising a coolant feed connection 180 that is tapered outwardly to more smoothly and efficiently direct coolant flow into a coolant inlet collar 300. Finally, in other applications, it may be desired to correct non-uniform flow of coolant entering a coolant inlet collar 300 of a heat exchanger 160. In such applications, an inlet flow splitter 702 may be incorporated in a coolant feed elbow 700 to create a more uniform inlet coolant flow thereby increasing the thermal efficiency of the EGR system 150, as well as potential longevity of a coolant inlet collar 300 associated therewith.

The many features and advantages of the disclosure are apparent from the detailed specification, and, thus, it is intended by the appended claims to cover all such features and advantages of the disclosure which fall within its true spirit and scope. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claim:

1. A heat exchanger for an exhaust gas recirculation system comprising:
a tube core including a plurality of tubes extending from an upstream header of the tube core to a downstream header of the tube core, the tube core including a plurality of coolant channels disposed between and separating the plurality of tubes; and
a coolant inlet collar disposed about the tube core proximate the upstream header, wherein the coolant inlet collar is comprised of at least two separately formed pieces that have been joined together.

2. The heat exchanger for an exhaust gas recirculation system of claim 1 wherein at least one of the separately formed pieces of the coolant inlet collar is an outer sleeve portion and at least one of the separately formed pieces of the coolant inlet collar is an inner core portion, wherein the inner core portion is shaped to be received within the outer sleeve portion.

3. The heat exchanger for an exhaust gas recirculation system of claim 2 wherein the outer sleeve portion of the coolant inlet collar has sidewalls incorporated thereon.

4. The heat exchanger for an exhaust gas recirculation system of claim 2 wherein the inner core portion of the coolant inlet collar has sidewalls incorporated thereon.

5. The heat exchanger for an exhaust gas recirculation system of claim 2 wherein the outer sleeve portion of the coolant inlet collar and the inner core portion of the coolant inlet collar are brazed or welded together.

6. The heat exchanger for an exhaust gas recirculation system of claim 1 wherein the coolant inlet collar is comprised of at least three separately formed pieces that have been joined together.

7. The heat exchanger for an exhaust gas recirculation system of claim 1 wherein at least one of the separately formed pieces of the coolant inlet collar is a core portion having an edge face thereon and at least one of the separately formed pieces of the coolant inlet collar is a faceplate, wherein the faceplate is shaped to be received on the edge face of the core portion.

8. The heat exchanger for an exhaust gas recirculation system of claim 1 wherein at least one of the separately formed pieces of the coolant inlet collar is a first half and at least one of the separately formed pieces of the coolant inlet collar is a second half.

9. The heat exchanger for an exhaust gas recirculation system of claim 1 further comprising a coolant feed connection having an interior channel for providing coolant flow to the coolant inlet collar.

10. The heat exchanger for an exhaust gas recirculation system of claim 9 wherein the interior channel of the coolant feed connection for the coolant inlet collar is outwardly tapered.

11. The heat exchanger for an exhaust gas recirculation system of claim 9 wherein the interior channel of the coolant feed connection for the coolant inlet collar includes a tapered flow deflector.

12. A heat exchanger for an exhaust gas recirculation system comprising:
a tube core including a plurality of tubes extending from an upstream header of the tube core to a downstream header of the tube core, the tube core including a plurality of coolant channels disposed between and separating the plurality of tubes; and
a coolant inlet collar disposed about the tube core proximate the upstream header, wherein the coolant inlet collar has a coolant feed elbow for supplying coolant to the coolant inlet collar, the coolant feed elbow having a flow splitter fitted therein, the flow splitter comprising a transversely-oriented wall bisecting the coolant feed elbow.

13. The heat exchanger for an exhaust gas recirculation system of claim 12 wherein the coolant feed elbow flow splitter is between approximately 1 mm and 10 mm in width.

14. The heat exchanger for an exhaust gas recirculation system of claim 12 wherein the coolant feed elbow flow splitter is between approximately 3 mm and 6 mm in width.

15. The heat exchanger for an exhaust gas recirculation system of claim 12 wherein the coolant feed elbow flow splitter terminates prior to an entrance to the coolant inlet collar forming a collar.

16. The heat exchanger for an exhaust gas recirculation system of claim 12 wherein the coolant feed elbow flow splitter terminates at the coolant inlet collar.

17. A method of assembling an inlet collar for an exhaust gas recirculation system, the method comprising the steps of:
selecting at least a first portion of a coolant inlet collar;
selecting at least a second portion of a coolant inlet collar;
combining the selected portions to create a finished coolant inlet collar.

18. The method of claim 17 wherein the step of combining the selected portions of a coolant inlet collar includes the step of combining by welding or brazing.

19. The method of claim 17 wherein the step of selecting a first portion of a coolant inlet collar includes the step of selecting an outer sleeve portion and the step of selecting a second portion of a coolant inlet collar includes the step of selecting an inner core portion that is shaped to be received within the outer sleeve portion.

20. The method of claim 17 wherein the step of selecting a first portion of a coolant inlet collar includes the step of selecting a core portion having an edge face thereon and the step of selecting a second portion of a coolant inlet collar includes the step of selecting a faceplate, wherein the faceplate is shaped to be received on the edge face of the core portion.
